(19) United States
(12) Patent Application Publication
(10) Pub. No.: US 2026/0205509 A1
(43) Pub. Date: Jul. 16, 2026

(54) MULTICOMPUTER DATA TRANSFERRING

(71) Applicant: Esker S.A., Lyon (FR)

(72) Inventors: Florian Geillon, Lyon (FR); Xavier Jean-Philippe Antoine Folch, Villeurbanne (FR); Jérémy Michel Carlo Espinas, Lyon (FR)

(21) Appl. No.: 19/023,853

(22) Filed: Jan. 16, 2025

(51) Int. Cl. H04L 67/06; H04L 41/22; H04L 45/033

(52) U.S. Cl. CPC H04L 67/06; H04L 45/033; H04L 41/22

(57) ABSTRACT

A system includes non-transitory computer-readable storage media storing instructions and an electronic processor configured to execute the instructions to receive a data transfer request, the data transfer request identifying a source entity, and validate a set of completed data transfers associated with the source entity against a set of heuristics. In response to determining that multiple heuristics are validated or that no heuristics are validated, the electronic processor is configured to initialize a set of logical rules, select a first subset of a set of routing instructions, select a second subset of the first subset of routing instructions, generate a vector representation for each routing instruction of the second subset of routing instructions, generate a reference vector, and select candidate routing instructions from the second subset of routing instructions. The electronic processor is configured to output the candidate routing instructions to a user device via a graphical user interface.

### FIELD

The present disclosure relates to multicomputer data transfer systems and, more particularly, to multicomputer data transfer systems that generate data package transmission routing instructions according to machine learning techniques.

### SUMMARY

Data transfer systems may transfer data packages from a computing platform associated with a source entity to one or more computing platforms associated with one or more destination entities. When data transfer requests include information specifying a source entity and a destination entity, the data transfer system can route the data package according to the specified routing instructions. However, when data transfer requests are missing destination entity information or when the destination entity information is otherwise corrupted or unusable, the data transfer system may not be able to accurately route the data package. Systems, apparatuses, methods, and techniques described in this specification provide technical solutions to these and other problems by leveraging computationally efficient machine learning techniques to automatically generate routing instructions for routing data packages between source and destination entities based on characteristics of previously completed data transfers.

As will be described in detail, various examples of the data transfer system implement a two-tiered approach to generate candidate routing instructions, utilizing a lightweight pattern-matching data transfer model when encountering relatively common scenarios and a context-aware data transfer model when encountering relatively complex scenarios. For example, the data transfer system receives a data transfer request that includes source entity metadata identifying the source entity of the data transfer. However, in some scenarios, the destination entity is missing from the data transfer request (or is otherwise unusable). To generate candidate routing instructions for routing the data package when the destination entity information is unusable, the data transfer system initially deploys the pattern-matching data transfer model to analyze previously completed data transfers to determine whether the previously completed data transfers satisfy a single heuristic from a set of predefined heuristics. When a single heuristic is matched, the pattern-matching data transfer model generates the candidate routing instructions based on the matched heuristic.

However, when multiple heuristics are matched or when no heuristics are satisfied, the data transfer system activates the context-aware data transfer model. In some instances, the context-aware data transfer model refines a set of candidate criteria by analyzing previously completed data transfers associated with the source entity. The refined criteria is matched against routing instructions in a data transfer routing schema to identify a set of possible routing instructions. An algorithm is applied to select a subset of the matched routing instructions that align with characteristics of the payload in the data transfer request. For each routing instruction in the subset, a vector is computed, with each element of the vector representing a characteristic of the routing instruction. A reference vector is computed based on the previously completed data transfers, with each element of the reference vector corresponding to the same characteristic as the elements in the routing instruction vectors. The context-aware data transfer model selects candidate routing instructions from the subset of the matched routing instructions based on a closeness between the routing instruction vector and the reference vector.

Thus, systems, apparatuses, methods, and techniques described in this specification provide a variety of technical benefits and solve a variety of technical problems. For example, the previously described two-tiered approach provides, among other things, for increased horizontal scalability by allowing the data transfer system to process high volumes of common data transfers using the computationally lightweight pattern-matching data transfer model and escalate complex data transfers to the context-aware data transfer model for additional processing as necessary.

Additionally, the context-aware data transfer model provides a computationally efficient alternative to traditional neural networks for generating routing instructions based on up-to-date historical data transfers, including real-time or near real-time data. Traditional neural networks often require computationally intensive retraining to incorporate information from new historical data transfers, which can be resource-prohibitive in environments with constrained computational capacity. By contrast, the context-aware data transfer model is capable of updating the reference vector to capture the characteristics of new historical data transfers dynamically and with relatively low computational cost. This approach facilitates efficient adaptation to evolving historical data patterns and allows for deployment to resource-limited environments, such as edge computing scenarios, where retraining neural networks may be impractical.

In some instances, the data transfer system also enhances transparency and traceability by explicitly defining each element in the vectors used in the context-aware data transfer model. Traditional deep learning models often lack interpretability, providing little ability to clearly explain why a particular decision may have been made. This opacity can make it difficult for users to understand the model's underlying reasoning, reducing confidence in the model's outputs. By contrast, each element in the vector representing the candidate routing instructions may represent a specific, understandable factor that contributes to the routing decision. This allows the model's decision-making process to be more explainable, creating an audit trail that operators can review to understand the exact reasoning behind each routing recommendation. This approach fosters accountability and trust, as users gain visibility into the factors driving the system's decisions.

In some instances, the data transfer system generates a confidence score for each candidate routing instruction based on vector similarity measures, which provides a quantitative measure of certainty for each recommendation. In some instances, the system implements a defined threshold and output only high-certainty recommendations (e.g., routing instructions having confidence scores above the threshold) to the user, which helps to improve the reliability of the system's outputs. This confidence-based filtering supports trust in the system by offering reliable routing instructions, enhancing trust and overall system reliability.

According to some examples, a system includes non-transitory computer-readable storage media storing instructions and an electronic processor. The electronic processor is configured to execute the instructions to receive a data transfer request, the data transfer request identifying a source entity and including a payload identifying a value, and validate a set of completed data transfers associated with the source entity against a set of heuristics. In response to determining that multiple heuristics are validated or that no heuristics are validated, the electronic processor is configured to execute the instructions to initialize a set of logical rules based on the set of completed data transfers, select a first subset of a set of routing instructions based on the initialized set of logical rules, select a second subset of the first subset of routing instructions, generate a vector representation for each routing instruction of the second subset of routing instructions, generate a reference vector based on the completed data transfers, and select candidate routing instructions from the second subset of routing instructions based on a comparison between each vector representation and the reference vector. The electronic processor is configured to execute the instructions to output the candidate routing instructions to a user device via a graphical user interface. A sum of payloads of the second subset of routing instructions is substantially equal to the payload of the data transfer request.

In other features, the electronic processor is configured to execute the instructions to transmit a data transfer command to a source node identified by the candidate routing instructions. In response to receiving the data transfer command, the source node is configured to transmit a data package to a destination node. In other features, the comparison between each vector representation and the reference vector includes computing a distance metric between each vector representation and the reference vector. In other features, each vector representation is normalized and the distance metric includes a scalar product.

In other features, the electronic processor is configured to execute the instructions to compute a confidence score based on the distance metric. In other features, the electronic processor is configured to execute the instructions to select a third subset of the second subset of routing instructions having a confidence score exceeding a predefined threshold as candidate routing instructions. In other features, the comparison between each vector representation and the reference vector includes ranking each vector representation according a distance between the vector representation and the reference vector.

In other features, the electronic processor is configured to execute the instructions to select a subset of the ranked vector representations as candidate routing instructions. In other features, the electronic processor is configured to execute the instructions to store at least one of the vector representation, the reference vector, and the confidence score to an explainability log. In other features, the electronic processor is configured to execute the instructions to generate candidate routing instructions based on the single heuristic in response to determining that only a single heuristic is validated.

Other methods provide a computer implemented method that includes receiving, at a data transfer management platform, a data transfer request, the data transfer request identifying a source entity and including a payload identifying a value and validating, at the data transfer management platform, a set of completed data transfers associated with the source entity against a set of heuristics. In response to determining that multiple heuristics are validated or that no heuristics are validated, the method includes initializing, at the data transfer management platform, a set of logical rules based on the set of completed data transfers, selecting, at the data transfer management platform, a first subset of a set of routing instructions based on the initialized set of logical rules, selecting, at the data transfer management platform, a second subset of the first subset of routing instructions, generating, at the data transfer management platform, a vector representation for each routing instruction of the second subset of routing instructions, generating, at the data transfer management platform, a reference vector based on the completed data transfers, and selecting, at the data transfer management platform, candidate routing instructions from the second subset of routing instructions based on a comparison between each vector representation and the reference vector. The method include outputting, from the data transfer management platform, the candidate routing instructions to a user device via a graphical user interface. A sum of payloads of the second subset of routing instructions is substantially equal to the payload of the data transfer request.

In other features, the method includes transmitting a data transfer command to a source node identified by the candidate routing instructions. In response to receiving the data transfer command, the source node is configured to transmit a data package to a destination node. In other features, the comparison between each vector representation and the reference vector includes computing a distance metric between each vector representation and the reference vector. In other features, each vector representation is normalized and the distance metric includes a scalar product.

In other features, the method includes computing a confidence score based on the distance metric. In other features, the method includes selecting a third subset of the second subset of routing instructions having a confidence score exceeding a predefined threshold as candidate routing instructions. In other features, the comparison between each vector representation and the reference vector includes ranking each vector representation according a distance between the vector representation and the reference vector.

In other features, the method includes selecting a subset of the ranked vector representations as candidate routing instructions. In other features, the method includes storing at least one of the vector representation, the reference vector, and the confidence score to an explainability log.

Other examples provide a non-transitory computer-readable storage medium including instructions that, when executed by an electronic processor, cause the electronic processor to perform a set of operations includes receiving a data transfer request, the data transfer request identifying a source entity and including a payload identifying a value and validating a set of completed data transfers associated with the source entity against a set of heuristics. In response to determining that multiple heuristics are validated or that no heuristics are validated, the instructions cause the electronic processor to perform a set of operations including initializing a set of logical rules based on the set of completed data transfers, selecting a first subset of a set of routing instructions based on the initialized set of logical rules, selecting a second subset of the first subset of routing instructions, generating a vector representation for each routing instruction of the second subset of routing instructions, generating a reference vector based on the completed data transfers, and selecting candidate routing instructions from the second subset of routing instructions based on a comparison between each vector representation and the reference vector. The instructions cause the electronic processor to perform a set of operations including generating candidate routing instructions based on the single heuristic in response to determining that only a single heuristic is validated and outputting the candidate routing instructions to a user device via a graphical user interface. A sum of payloads of the second subset of routing instructions is substantially equal to the payload of the data transfer request.

Other examples, implementations, features, and aspects will become apparent by consideration of the detailed description and accompanying drawings.

### BRIEF DESCRIPTION OF THE DRAWINGS

FIG. 1 is a block diagram of a data transfer system, according to some examples.

FIG. 2 is a block diagram illustrating a source node, according to some examples.

FIG. 3 is a schematic illustration of a data structure implementing entities, according to some examples.

FIG. 4 is a block diagram illustrating a destination node, according to some examples.

FIG. 5 is a schematic illustration of a data structure implementing entities, according to some examples.

FIG. 6 is a block diagram illustrating a data transfer management platform, according to some examples.

FIG. 7 illustrates a schematic representation of a data transfer routing schema, according to some examples.

FIG. 8 illustrates a schematic representation of data transfer instructions, according to some examples.

FIG. 9 illustrates a schematic representation of a data transfer log, according to some examples.

FIGS. 10 and 11 present a message sequence chart illustrating interactions between components of a data transfer system during execution of a data transfer, according to some examples.

FIG. 12 illustrates a schematic representation of a data transfer request, according to some examples.

FIG. 13 illustrates a schematic representation of candidate routing instructions, according to some examples.

In the drawings, reference numbers may be reused to identify similar and/or identical elements.

### DETAILED DESCRIPTION

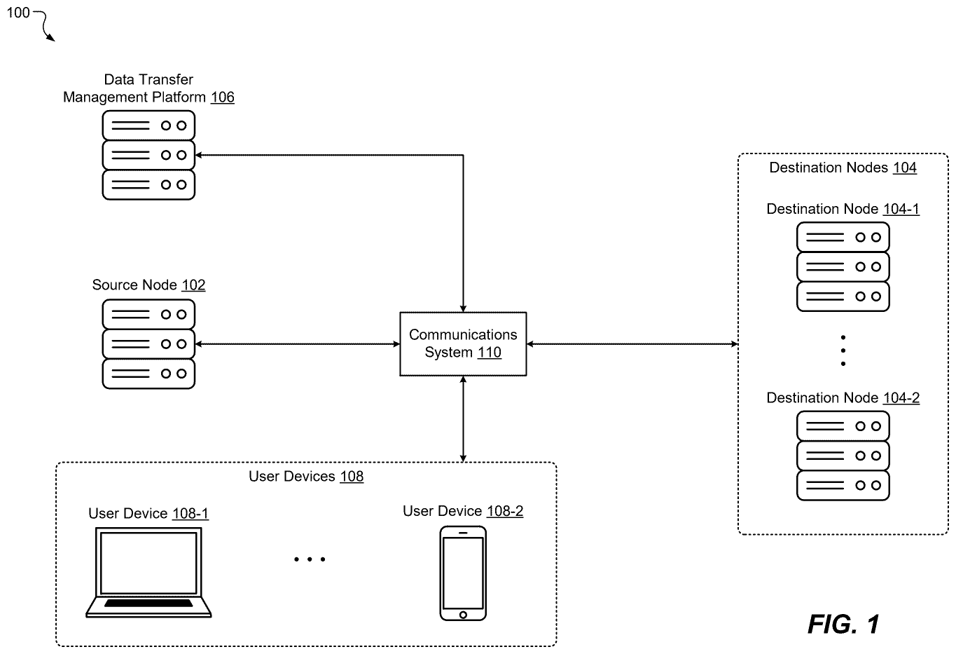

FIG. 1 is a block diagram of a data transfer system 100, according to some examples. In one example, the data transfer system 100 includes a source node 102, one or more destination nodes 104 (such as, for example, destination nodes 104-1 and 104-2), a data transfer management platform 106, one or more user devices 108 (such as, for example, user devices 108-1 and 108-2), and/or a communications system 110. Although a single source node 102, two destination nodes 104, a single data transfer management platform 106, two user devices 108, and a single communications system 110 is illustrated in the example of FIG. 1, other implementations of the data transfer system 100 include a different number of each node, device, platform, database, or system. Additionally, although these elements are illustrated as discrete, individual elements in FIG. 1, one or more of the elements are combined into a single component and/or split across multiple components in certain configurations.

In the example shown, the source node 102, destination nodes 104, data transfer management platform 106, and/or user devices 108 communicate with one another via the communication system 110. For example, the source node 102 transmits a data package to a destination node 104 via the communications system 110. In various implementations, the data transfer management platform 106 manages data transfers within the system 100. For example, a user device 108 transmits a data transfer request to the data transfer management platform 106. When the data transfer request specifies both a source entity and a destination entity, the data transfer management platform 106 transmits a command to the source node 102 for the source node 102 to transmit the data package to the appropriate destination node 104 associated with the specified destination entity. However, when the data transfer request does not specify a destination entity or the destination entity is otherwise unusable (for example, when corrupted during transmission), the data transfer management platform 106 generates candidate routing instructions based on previously completed data transfers associated with the source entity.

In various implementations, the source node 102, destination nodes 104, data transfer management platform 106, and/or user devices 108 are each implemented as a computing platform or as part of a computing platform. Examples of suitable computing platforms include on-premises servers, distributed systems, cloud infrastructures, and/or hybrid deployments that combine multiple deployment models. In some examples, the computing platforms are implemented as local servers, clusters of distributed servers, or components within scalable cloud computing environments. Suitable cloud technologies may include platform-as-a-service (PaaS) solutions, container orchestration systems (e.g., Kubernetes), serverless computing platforms, and/or managed hosting services. In various implementations, the computing platforms include dedicated bare-metal servers, content delivery networks (CDNs), and/or web hosting services, depending on the specific requirements of the application.

In some instances, user devices 108 include one or more personal or mobile computing platforms that facilitate user interaction with components of the data transfer system 100. Examples of suitable platforms include personal computers (PCs) and/or workstations, as well as portable devices such as laptops, tablets, and/or smartphones. In various implementations, user devices 108 serve as access points for initiating, monitoring, or managing data transfer requests and support various operating systems (e.g., Windows, macOS, iOS, Android) and interfaces. Various implementations of the user devices 108 include web browsers, standalone desktop applications, and/or mobile apps for connecting to and interacting with components of the data transfer system 100, such as the data transfer management platform 106.

Various implementations of the communications system 110 include a combination of a variety of networks that support data transmission between components of the data transfer system 100. Examples of suitable networks include wireless and wired communication systems. Wireless networks include cellular networks such as General Packet Radio Service (GPRS), Time-Division Multiple Access (TDMA), Code-Division Multiple Access (CDMA), Global System for Mobile Communications (GSM), Enhanced Data Rates for GSM Evolution (EDGE), High-Speed Packet Access (HSPA), Evolved High-Speed Packet Access (HSPA+), Long Term Evolution (LTE), Worldwide Interoperability for Microwave Access (WiMAX), 5th-generation mobile networks (5G), etc. Various examples of wireless networks also include local wireless networks, such as those implanted based on IEEE 802.11 standards (e.g., Wi-Fi) or Wireless Application Protocol (WAP). In some instances, wired communication systems include optical networks, local area networks (LANs), and global communication networks such as the Internet.

In various implementations, the communications system 110 uses a combination of these network types to provide reliable and efficient connectivity between components of the data transfer system 100.

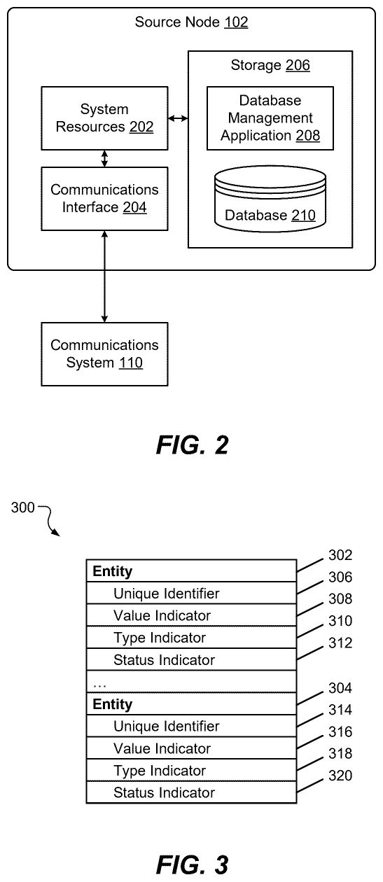

FIG. 2 is a block diagram illustrating a source node 102, according to some examples. In the example shown, the source node 102 includes system resources 202, a communications interface 204, and non-transitory computer-readable storage media, such as, for example storage 206. In various implementations, the system resources 202 include one or more electronic processors and/or one or more graphics processing units for executing instructions stored in the storage 206, volatile computer memory, non-volatile computer memory, and/or one or more system buses interconnecting the components of the source node 102 (such as any of the previously described components). The communications interface 204 includes one or more components configured to facilitate communication via the communications system 110. For example, the communications interface 204 includes one or more transceivers and associated circuitry for handling data communications via the communications system 110.

In various implementations, the storage 206 includes a database management application 208 that manages digital resources recorded or stored in a database 210 and/or generates data transfer requests for transferring digital resources. In some examples, collections of related or associated digital resources are referred to as an entity. Thus, in some instances, an entity refers to a structured data object or data structure that encapsulates a collection of related digital resources, for example, including their attributes and operational states. Examples of suitable data structures for implementing entities include class-based data structures, struct or record-based data structures, dictionary-based representations, composite design patterns, graph-based representations, relational database schemas, JSON objects, immutable data structures such as tuples, etc.

Class-based data structures represent entities as object-oriented abstractions that encapsulate both attributes (e.g., fields describing the entity and its associated digital resources) and behaviors (e.g., methods or commands defining actions that can be performed with these resources). Attributes include a unique identifier identifying the entity, a value indicator representing a quantity of digital resources associated with the entity, a type indicator specifying the classification of the digital resources, and/or an availability status indicator specifying an operation state of the digital resources, while behaviors specify operations such as reserving, transferring, or modifying the associated resources.

Struct or record-based data structures represent entities as collections of fields that encapsulate attributes. Examples of fields include a unique identifier identifying the entity, a value indicator representing a quantity of digital resources associated with the entity, a type indicator specifying the classification of the digital resources, and/or an availability status indicator specifying an operation state of the digital resources. Each field is defined with a specific data type, such as strings for identifiers and types or numerical values for resource quantities.

Dictionary-based representations define entities as key-value pairs, where each key corresponds to an attribute name and each value holds the associated data. Examples of keys include a unique identifier key, a value indicator key, a type indicator key, and/or an availability status key. Values are assigned to each corresponding key. For example, the unique identifier key is assigned a value identifying the entity, the value indicator key is assigned a value representing a quantity of digital resources associated with the entity, the type indicator key is assigned a value specifying the classifier of the digital resources, and/or the availability status key is assigned a value specifying an operational state of the digital resources.

Graph-based representations model entities as nodes within a graph, with edges connecting the nodes representing relationships or interactions between the nodes. Each node includes attributes such as an entity identifier, a value indicator specifying the quantity of digital resources, a type indicator classifying the resources, and/or an availability status indicator reflecting their operational state. In various implementations, edges include metadata about transactions or dependencies between nodes.

Relational database schemas represent entities as rows in database tables, where each row corresponds to a distinct entity, and columns represent attributes of the entity. For example, columns include a unique identifier column that identifies the entity, a value indicator column that represents the quantity of digital resources associated with the entity, a type indicator column that specifies the classification of the digital resources, and/or an availability status indicator column that specifies the operational state of the digital resources. The value at the intersection of each column and row represents the specific value of the attribute for the entity identified by that row. For instance, the value at the intersection of the unique identifier column and a row identifies the entity associated with that row, the value at the intersection of the value indicator column and a row represents the quantity of digital resources linked to that entity, the value at the intersection of the type indicator column and a row specifies the classification of those digital resources, and/or the value at the intersection of the availability status indicator column and a row represents the operational state of those digital resources. In other implementations, this schema is transposed such that rows represent attributes and columns represent entities, with values at their intersections representing corresponding attribute values for each entity.

JSON objects represent entities as structured text-based objects containing key-value pairs. Examples of keys include a unique identifier key, a value indicator key, a type indicator key, and/or an availability status key. Values are assigned to each corresponding key. For example, the unique identifier key is assigned a value identifying the entity, the value indicator key is assigned a value representing a quantity of digital resources associated with the entity, the type indicator key is assigned a value specifying the classifier of the digital resources, and/or the availability status key is assigned a value specifying an operational state of the digital resources.

Immutable data structures such as tuples represent entities as fixed collections of fields that cannot be modified after creation. Each field corresponds to an attribute, such as a unique identifier identifying the entity, a value indicator representing a quantity of digital resources associated with the entity, a type indicator specifying the classification of the digital resources, and/or an availability status indicator specifying an operational state of the digital resources. Once initialized with values for these fields, immutable data structures ensure that the state of the entity remains unchanged throughout its lifecycle.

In various implementations, each entity is associated with a financial account. For example, the unique identifier of each entity corresponds to a specific financial account, and the digital resources described by the entity, such as resource quantities, classifications, and operational states, are linked to that financial account.

FIG. 3 is a schematic illustration of a data structure 300 implementing entities, according to some examples. In various implementations, the data structure 300 is stored within the database 210. In the example of FIG. 3, the data structure 300 implements an entity 302 and an entity 304. While FIG. 3 illustrates two entities 302 and 304, other implementations of the data structure 300 include a different number of entities.

As previously described, the data structure 300 includes, for each entity, a unique identifier identifying the entity, a value indicator representing the quantity of digital resources linked to the entity, a type indicator specifying the classification of the digital resources, and/or an availability status indicator indicating the operational state or the transfer readiness of those resources. In various implementations, the value indicator represents the quantity of digital resources associated with the entity and may be expressed as a numerical value. For example, the value indicator may reflect 1,000 units of a fiat currency, such as U.S. dollars, or 2.5 units of a cryptocurrency, such as bitcoin. In some instances, this indicator quantifies the total amount of digital resources currently linked to the entity.

In various implementations, the type indicator provides metadata that classifies the nature of the digital resources associated with the entity. For example, this classification may include distinctions between fiat currencies (e.g., “USD” for U.S. dollars, “EUR” for euros, etc.), cryptocurrencies (e.g., “BTC” for bitcoin, “ETH” for Ethereum, etc.), or other electronically managed units of value, such as tokenized assets. Additionally, the type indicator may specify further attributes, such as denominations, subtypes, or unique identifiers, to ensure precise resource categorization.

In some instances, the availability status indicator represents the current operational state of the digital resources associated with the entity (for example, indicating their readiness for transfer). For example, the availability status may show that the resources are ready for transfer, meaning they can immediately fulfill a data transfer request. The availability status may indicate that the resources are pending transfer, signifying that a transaction involving the resources is in progress and they are temporarily unavailable. The indicator may reflect that the resources are reserved, meaning they are allocated for a specific purpose or future transaction and are not currently accessible for other operations.

In the example illustrated in FIG. 3, the data structure 300 includes a unique identifier 306, a value indicator 308, a type indicator 310, and an availability status indicator 312 for the entity 302. Similarly, the entity 304 includes a unique identifier 314, a value indicator 316, a type indicator 318, and a status indicator 320. Together, these indicators may provide a structured and comprehensive representation of the digital resources represented by the data structure 300, supporting efficient and accurate data transfer operations within the data transfer system 100.

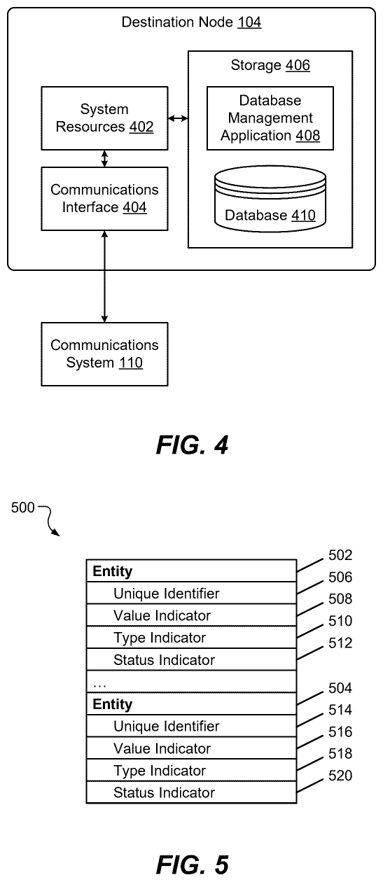

FIG. 4 is a block diagram illustrating a destination node 104, according to some examples. In some instances, the destination node 104 includes system resources 402, a communications interface 404, and non-transitory computer-readable storage media, such as, for example storage 406. In various implementations, system resources 402 includes one or more electronic processors and/or one or more graphics processing units for executing instructions stored in the storage 406, volatile computer memory, non-volatile computer memory, and/or one or more system buses interconnecting the components of the destination node 104 (such as any of the previously described components). The communications interface 404 includes one or more components configured to facilitate communication via the communications system 110. For example, the communications interface 404 includes one or more transceivers and associated circuitry for handling data communications via the communications system 110.

In various implementations, the storage 406 includes a database management application 408 that manages digital resources recorded or stored in a database 410 and/or generates data transfer requests for transferring digital resources. FIG. 5 is a schematic illustration of a data structure 500 implementing entities, according to some examples. In various implementations, the data structure 500 is stored within the database 410. In the example of FIG. 5, the data structure 500 implements an entity 502 and an entity 504. While FIG. 5 illustrates two entities 502 and 504, other implementations of the data structure 500 include a different number of entities.

Similar to the data structure 300, the data structure 500 includes, for each entity, a unique identifier, a value indicator, a type indicator, and an availability status indicator. These indicators may function in the same manner as previously described with reference to the data structure 300, representing the quantity, classification, and availability of the digital resources associated with each entity. As illustrated in FIG. 5, the data structure 500 includes a unique identifier 506, a value indicator 508, a type indicator 510, and a status indicator 512 for the entity 502. Similarly, the entity 504 includes a unique identifier 514, a value indicator 516, a type indicator 518, and a status indicator 520.

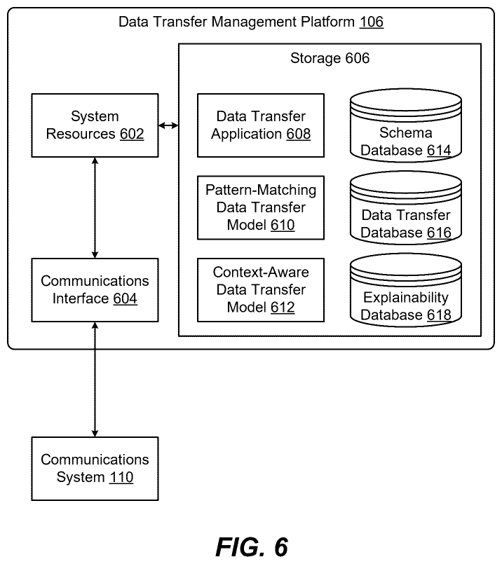

FIG. 6 is a block diagram illustrating a data transfer management platform 106, according to some examples. In the example shown, the data transfer management platform 106 includes system resources 602, a communications interface 604, and non-transitory computer-readable storage media, such as, for example storage 606. In some instances system resources 602 include one or more electronic processors and/or one or more graphics processing units for executing instructions stored in the storage 606, volatile computer memory, non-volatile computer memory, and/or one or more system buses interconnecting the components of the data transfer management platform 106 (such as any of the previously described components). In various implementations, the communications interface 604 includes one or more components configured to facilitate communication via the communications system 110. For example, the communications interface 604 includes one or more transceivers and associated circuitry for handling data communications via the communications system 110.

In various implementations, the storage 606 of the data transfer management platform 106 includes a data transfer application 608, a pattern-matching data transfer model 610, a context-aware data transfer model 612, a schema database 614, a data transfer database 616, and/or an explainability database 618. In some instances, these components work together to facilitate and manage data transfers within the data transfer system 100. The data transfer application 608 orchestrates data transfers (e.g., the transfer of data packages between source and destination entities) within the data transfer system 100, ensuring that digital resources are accurately routed.

In some instances, the data transfer application 608 receives a data transfer request from a user device 108. When the data transfer request explicitly specifies both a source entity and a destination entity, the data transfer application 608 generates routing instructions for transferring the data package based on the specified source entity and destination entity. As previously described, when the destination entity information is missing or otherwise unusable, the data transfer application 608 generates candidate routing instructions using the pattern-matching data transfer model 610 or the context-aware data transfer model 612. As will be described in detail, the pattern-matching data transfer model 610 and the context-aware data transfer model 612 generate candidate routing instructions based on characteristics of previously completed data transfers associated with the source entity stored in the data transfer database 616.

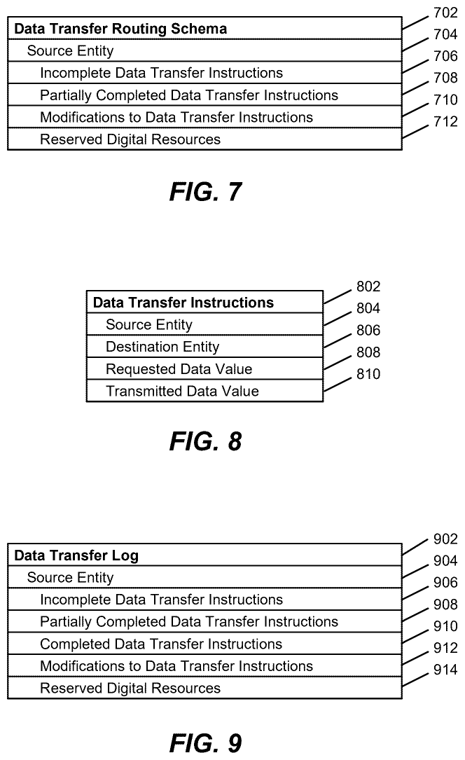

The schema database 614 stores one or more data transfer routing schemas that define how digital resources may be routed from a source entity to one or more destination entities. In various implementations, the data transfer routing schemas represent allocation lists including invoices awaiting payment (e.g., unpaid and/or partially paid invoices), set aside amounts, etc. FIG. 7 illustrates a schematic representation of a data transfer routing schema 702, according to some examples. The data transfer routing schema 702 includes elements associated with a source entity 704. In some instances, these elements include incomplete data transfer instructions 706, partially completed data transfer instructions 708, modifications to data transfer instructions 710, and/or reserved digital resources 712 linked to the source entity 704.

In some instances, the incomplete data transfer instructions 706 include data transfer instructions that request digital resources to be transferred from the source entity 704, which have not yet been initiated. In various implementations, the incomplete data transfer instructions 706 represent invoices awaiting payment by the source entity 704. FIG. 8 illustrates a schematic representation of data transfer instructions 802, according to some examples. In this example, the data transfer instructions 802 include one or more elements defining a request for transfer of digital resources from a source entity to a destination entity. In the example of FIG. 8, the data transfer instructions 802 include a source entity 804, a destination entity 806, a requested data value 808, and a transmitted data value 810. The source entity 804 specifies the source entity from which digital resources are requested. The destination entity 806 specifies the destination entity to which digital resources are requested to be transferred. The requested data value 808 specifies an amount or value of digital resources requested from the source entity 804. The transmitted data value 810 specifies an amount or value of digital resources already received from the source entity 804.

Returning to FIG. 7, in various implementations, the partially completed data transfer instructions 708 include data transfer requests for digital resource from the source entity 704 that have been partially (but not fully) completed. In some examples, the partially completed data transfer instructions 708 represent invoices that have been partially paid by the source entity 704. In some instances, the modifications to data transfer instructions 710 include modifications to the amount of digital resources requested from the source entity 704 (for example, modifications to the requested data value 808 element or the transmitted data value 810 element of data transfer instructions such as the data transfer instructions 802). In various implementations, the modifications to data transfer instructions 710 represent credits applied to outstanding or partially paid invoices associated with the source entity 704. In some instances, the reserved digital resources 712 represent digital resources associated with the source entity 704 that have been reserved for future data transfers. In some examples, the reserved digital resources 712 represent digital resources that have been set aside because associated invoices may not yet have been issued or processed or have been canceled.

Returning to FIG. 6, in some instances, the data transfer database 616 includes information recording historical data transfers completed over the data transfer system 100. For example, the data transfer application 608 monitors data transfers and logs the data transfers in a data transfer log stored at the data transfer database 616. In various implementations, the data transfer log represents previously validated allocations associated with a source entity. FIG. 9 illustrates a schematic representation of a data transfer log 902, according to some examples. In the example of FIG. 9, the data transfer log 902 is stored at the data transfer database 616 and includes various elements associated with a source entity 904. In various implementations, the elements include incomplete data transfer instructions 906, partially completed data transfer instructions 908, completed data transfer instructions 910, modifications to data transfer instructions 912, and/or reserved digital resources 914.

The incomplete data transfer instructions 906 include information related to data transfer requests for digital resources from the source entity 904 that have been requested but not yet started. In various implementations, the incomplete data transfer instructions 906 represents unpaid but outstanding invoices. The partially completed data transfer instructions 908 include information related to data transfer requests for digital resources from the source entity 904 that have been partially completed. In some examples, the partially completed data transfer instructions 908 represent partially paid invoices. The completed data transfer instructions 910 include information related to data transfer requests for digital resources from the source entity 904 that have been completed. In various implementations, the completed data transfer instructions 910 represents fully paid invoices. The modifications to data transfer instructions 912 include modifications to amounts of digital resources previously requested from the source entity 904. In some examples, the modifications to data transfer instructions 912 represents credits or credit note previously applied to invoices. The reserved digital resources 914 include information related to previously reserved digital resources associated with the entity. In various implementations, the reserved digital resources 914 represents previously set aside amounts.

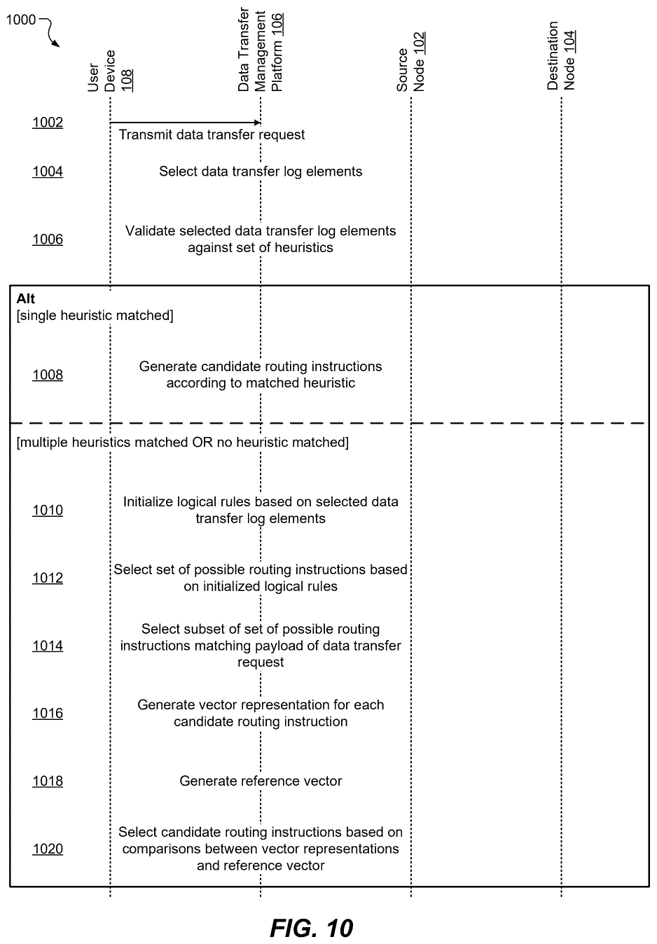

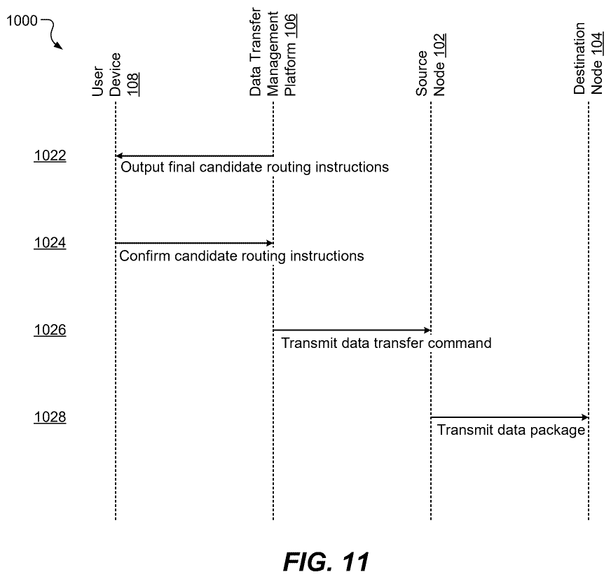

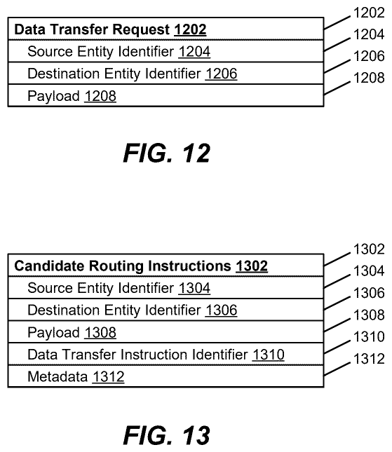

FIGS. 10 and 11 present a message sequence chart 1000 illustrating interactions between components of the data transfer system 100 during execution of a data transfer, according to some examples. In the example message sequence chart 1000, the user device 108 transmits a data transfer request to the data transfer application 608 of the data transfer management platform 106 (at operation 1002). FIG. 12 illustrates a schematic representation of a data transfer request 1202, according to some examples. In the example of FIG. 12, the data transfer request 1202 includes a source entity identifier 1204 identifying a source entity, a destination entity identifier 1206 identifying a destination entity, and a payload 1208. The payload 1208 identifies a value of digital resources to be transferred. In various implementations, the data transfer request 1202 represents a bank transfer without remittance advice (e.g., including only the issuer and the amount).

When the destination entity identifier 1206 is present and usable (e.g., not corrupted), the data transfer application 608 may generate routing instructions to transfer digital resources from the source entity identified by the source entity identifier 1204 to the destination entity identified by the destination entity identifier 1206. However, when the destination entity identifier 1206 is not present or is not usable, the data transfer application 608 generates candidate reference routing instructions based on historical competed data transfers associated with the source entity. For example, returning to FIGS. 10 and 11, in the message sequence chart 1000, the data transfer application 608 selects elements of the data transfer log 902 associated with the source entity identified by the source entity identifier 1204 (at operation 1004).

In the example message sequence chart 1000, the data transfer application 608 activates the pattern-matching data transfer model 610, which validates (or matches) the selected elements (associated with the source entity) against a predefined set of heuristics (at operation 1006). In various implementations, a heuristic represents a set of rules or guidelines that an algorithm—for example, an algorithm implemented by the pattern-matching data transfer model 610—can follow to make predictions or decisions. Table 1 below provides examples suitable heuristics. Additional or alternative heuristics may also be incorporated, depending on implementation requirements.

TABLE 1

| Heuristic | Description | Decision Logic |
|---|---|---|
| 1. Prioritizing | Verifies whether the source entity | Prioritizes data requests based on the |
| Oldest Outstanding | allocates the entire data payload to the | due date or creation date specified in |
| Instructions | oldest outstanding data transfer | the request metadata. |
| | instructions (e.g., invoices) associated | |
| | with the same destination entity. | |
| 2. Sequential | Determines whether the source entity | Distributes resources by due date or |
| Distribution Across | distributes the data payload | creation date in request metadata until |
| Instructions | sequentially across multiple | the transfer amount is exhausted. |
| | outstanding data transfer instructions | Marks partially fulfilled requests if |
| | linked to the same destination entity. | the transfer amount is insufficient. |
| 3. Prioritized | Evaluates whether the source entity | Allocates resources in order of due |
| Allocation with | allocates the data payload based on a | dates or creation dates in request |
| Resource | prioritized sequence of data transfer | metadata. Surplus resources are |
| Reservation | instructions and reserves any | marked as “reserved” in the digital |
| | remaining resources for future | ledger. |
| | transfers. | |

In the example message sequence chart 1000, when the pattern-matching data transfer model 610 determines that only a single heuristic from the set of heuristic from the set of heuristics is matched against the selected elements of the data transfer log 902, the pattern-matching data transfer model 610 generates candidate routing instructions according to the matched heuristic (at operation 1008). FIG. 13 illustrates a schematic representation of candidate routing instructions 1302, according to some examples. In the example of FIG. 13, the candidate routing instructions 1302 include a source entity identifier 1304, a destination entity identifier 1306, a payload 1308, a data transfer instruction identifier 1310, and/or metadata 1312. The source entity identifier 1304 identifies the source entity from which digital resources are to be transferred from. The destination entity identifier 1306 identifies the destination entity the digital resources are to be transferred to. The payload 1308 may specify an amount or value of digital resources to be transferred. The data transfer instruction identifier 1310 identifies the data transfer instruction or data transfer instructions the transfer of digital resources satisfies. The metadata 1312 includes auxiliary instructions, such as whether any amount of the digital resources is to be set aside or reserved.

As an illustrative example, when the pattern-matching data transfer model 610 determines that the first heuristic from Table 1 is matched, the pattern-matching data transfer model 610 generates candidate routing instructions 1302 according to the matched first heuristic. For example, the pattern-matching data transfer model 610 detects (e.g., from the historical data transfer records) that the source entity has consistently used a single destination entity and allocated the entire transfer amount to the oldest outstanding data transfer instruction associated with that destination entity. In response, the pattern-matching data transfer model 610 populates the source entity identifier 1304 with the identified source entity and populates the destination entity identifier 1306 with the identified destination entity. Because the first heuristic specifies that the full payload is always applied to the oldest instruction, the pattern-matching data transfer model 610 sets the payload 1308 to match the total requested data value of the oldest data transfer instruction from that destination entity. In various implementations, the data transfer instruction identifier 1310 identifies the specific instruction being fully satisfied by this allocation.

In a practical application, the first heuristic may be matched when the issuer (e.g., the source entity) consistently directs allocations to the same set of one or more customers, selects the oldest outstanding invoice (e.g., pending or unsatisfied data transfer instruction) according to the due date or invoice date, and applies a transfer amount (e.g., value of digital resources specified in the payload of the candidate routing instructions) that matches the requested data value of the oldest invoice. In this practical application, the pattern-matching data transfer model 610 generates candidate routing instructions 1302 where the source entity identifier 1304 matches the issuer, the destination entity identifier 1306 matches the one or more customers, the payload 1308 matches the requested data value of the oldest invoice, and the data transfer instruction identifier 1310 identifies the oldest outstanding invoice.

As another illustrative example, when the pattern-matching data transfer model 610 determines that the second heuristic from Table 1 is matched, the pattern-matching data transfer model 610 generates candidate routing instructions 1302 according to the matched second heuristic. For example, the pattern-matching data transfer model 610 detects (e.g., from the historical data transfer records) that the source entity systematically allocates the transfer amount across multiple outstanding data transfer instructions in ascending order of their due dates (or invoice dates) until the transfer amount is fully distributed. In response, the pattern-matching data transfer model 610 populates the source entity identifier 1304 with the identified source entity and the destination entity identifier 1306 with the identified destination entity. Because the second heuristic specifies that multiple instructions may be involved, the pattern-matching data transfer model 610 sets the payload 1308 to the entire transfer amount while generating a list of instructions that are fully or partially satisfied. The data transfer instruction identifier 1310 references each instruction included in the allocation, including any instruction that is partially fulfilled.

In another practical application, the second heuristic may be matched when the issuer (e.g., the source entity) distributes payment sequentially, beginning with the oldest outstanding invoice (e.g., the oldest data transfer instruction) and continuing to subsequent invoices until the transfer amount has been exhausted. In this practical application, the pattern-matching data transfer model 610 generates candidate routing instructions 1302 where the source entity identifier 1304 represents the issuer, the destination entity identifier 1306 indicates the one or more customers receiving payment, the payload 1308 reflects the total value of digital resources being allocated, and the data transfer instruction identifier 1310 identifies all invoices that have been fully or partially paid. Any invoice that cannot be fully satisfied is marked as partially paid, allowing the issuer to address its remaining balance in a subsequent transfer.

As another illustrative example, when the pattern-matching data transfer model 610 determines that the third heuristic from Table 1 is matched, the pattern-matching data transfer model 610 generates candidate routing instructions 1302 according to the matched third heuristic. For instance, the pattern-matching data transfer model 610 detects from the historical data transfer records that the source entity allocates the transfer amount to the oldest data transfer instruction(s) in full, then reserves any remaining portion of the transfer for future or unissued instructions. In response, the pattern-matching data transfer model 610 populates the source entity identifier 1304 with the identified source entity, populates the destination entity identifier 1306 with the appropriate destination entity or entities, and populates the payload 1308 for the amount being immediately allocated. In some instances, the data transfer instruction identifier 1310 identifies any instructions that have been fully satisfied, while the metadata 1312 includes a record of the reserved amount that has been set aside.

In another practical application, the third heuristic may be matched when the issuer (e.g., the source entity) provides a transfer that fully pays one or more outstanding invoices but retains a surplus for future allocations. In this practical application, the pattern-matching data transfer model 610 generates candidate routing instructions 1302 where the source entity identifier 1304 matches the issuer, the destination entity identifier 1306 matches the one or more customers who receive payment for their oldest outstanding invoice(s), the payload 1308 covers the total requested data value that is satisfied by the transfer, the data transfer instruction identifier 1310 references all invoices that are fully settled by this allocation, and the metadata 1312 indicates the reserved digital resources remaining for subsequent invoices that may not yet be issued, processed, or finalized.

Returning to FIGS. 10 and 11, in the example message sequence chart 1000, when the pattern-matching data transfer model 610 matches multiple heuristics against the selected elements of the data transfer log 902 or no heuristics are matched, the data transfer application 608 activates the context-aware data transfer model 612, which initializes a set of logical rules based on the selected elements of the data transfer log 902 (at operation 1010). In various implementations, the logical rules include binary (e.g., yes/no) determinations describing characteristics about how historical data transfers from the source entity were completed. In some examples, the logical rules identify entities, data transfer requests, other data structures, etc. affected by historical data transfers. In various implementations, the logical rules include computed characteristics describing aspects of historical data transfers. The context-aware data transfer model 612 analyzes the historical data transfers (e.g., the selected elements of the data transfer log 902) to initialize the logical rules in a way that accurately reflects the observed patterns and attributes of the historical data transfers. Table 2 below provides examples of suitable logical rules. Additional or alternative logical rules may also be incorporated, depending on implementation requirements.

TABLE 2

| Rule | Description of Rule Logic |
|---|---|
| Rule 1: Partial | Determines whether historical data transfers were made to satisfy |
| Allocations | partially completed data transfer instructions. |
| | Example implementation logic: Determine whether data transfer |
| | log 902 indicates that the source entity 904 transferred digital |
| | resources to destination entities in response to data transfer |
| | instructions 802 where the transmitted data value 810 is not zero. |
| | Example practical application: Determines whether the data transfer |
| | log 902 indicates that the issuer (e.g., source entity) previously made |
| | allocations on partial invoices. |
| Rule 2: Reserved | Determines whether digital resources associated with historical data |
| (Set-Aside) | transfers were reserved. |
| Allocations | Example implementation logic: Determine whether reserved digital |
| | resources 914 of the data transfer log 902 indicates that digital |
| | resources associated with previous data transfers were flagged as |
| | reserved (e.g., not transferred to satisfy data transfer instructions). |
| | Example practical application: Determine whether the data transfer |
| | log 902 indicates that the issuer (e.g., source entity) previously set |
| | aside amounts from a bank transfer to be applied later. |
| Rule 3: Affected | Determines which destination entities were affected by previous data |
| Destination | transfers. |
| Entities | Example implementation logic: Analyzes the data transfer log 902 to |
| | determine which destination entities the source entity 904 previously |
| | transferred digital resources to. |
| | Example practical application: Identifies which customers (e.g., |
| | destination entities) the issuer (e.g., source entity) previously made |
| | allocations to. |
| Rule 4: Credit | Determines whether modifications were applied to previous data |
| Note Retrieval | transfer instructions. |
| Rule | Example implementation logic: Analyzes the modifications to data |
| | transfer instructions 912 of the data transfer log 902 to determine |
| | whether modifications (e.g., reductions to the requested data value or |
| | increases to the transmitted data value fields of data transfer |
| | instructions) were made to previous data transfer instructions. |
| | Example practical application: Determines whether the data transfer |
| | log 902 indicates that the issuer historically applied credit notes or |
| | other adjustments to lower the amounts owed. |
| Rule 5: Previously | Determines whether the data transfer log 902 shows that digital |
| Reserved Amount | resources previously marked as “reserved” were subsequently applied |
| Retrieval | to new or updated data transfer instructions 802. |
| | Example implementation logic: Check whether reserved digital |
| | resources 914 in the data transfer log 902 were later assigned to satisfy |
| | subsequent data transfer instructions. |
| | Example practical application: Identifies whether the issuer (e.g., |
| | source entity) used previously set-aside funds from a prior transfer to |
| | pay future invoices. |

In the example message sequence chart 1000, the context-aware data transfer model 612 selects a set of possible routing instructions based on the initialized logical rules (at operation 1012). In various implementations, the data transfer routing schema 702 includes one or more routing instructions, for example, awaiting a partial or complete transfer of digital resources from the source entity. The context-aware data transfer model 612 may select the set of the possible routing instructions that satisfy the initialized logical rules. In the example message sequence chart 1000, the context-aware data transfer model 612 selects a subset of the set of possible instructions matching the payload 1208 of the data transfer request 1202 (at operation 1014). For example, the payload 1208 indicates a value of digital resources, and the context-aware data transfer model 612 applies an algorithm to select a subset of possible routing instructions such that the sum of the requested data values of the possible routing instructions is equal to or substantially equal to the value of digital resources indicated by the payload 1208. Each routing instruction in the selected subset of possible routing instructions may be referred to as a candidate routing instruction.

In the example message sequence chart 1000, the context-aware data transfer model 612 generates a vector representation for each candidate routing instruction in the set of candidate routing instructions (at operation 1016). In various implementations, each element of the vector represents a distinct characteristic, condition, or attribute of the respective candidate routing instruction. For example, the context-aware data transfer model 612 computes each vector by extracting and encoding various characteristics of the candidate routing instruction. The resulting vector elements include numerical values that represent the source entity's data transfer activity in a structured format suitable for analysis by machine learning models.

In various implementations, the context-aware data transfer model 612 computes a vector having six elements for each candidate routing instruction. Table 3 below illustrates examples of suitable elements for the vector, according to some practical applications. Additional or alternative elements may also be incorporated, depending on implementation requirements.

TABLE 3

| Vector Element | Description |
|---|---|
| 1 | Quantifies a number of the oldest data transfer |
| | instructions that are fully satisfied. |
| | In various practical applications, this vector |
| | element may represent a number of fully |
| | allocated invoices belonging to the oldest |
| | invoices by due date. |
| 2 | Quantifies a number of other data transfer |
| | instructions that are fully satisfied. |
| | In various practical applications, this vector |
| | element may represent a number of other |
| | invoices that are fully allocated. |
| 3 | Quantifies a number of partially satisfied data |
| | transfer instructions belonging to the oldest |
| | data transfer instructions. |
| | In various practical applications, this vector |
| | element may represent a number of partially |
| | allocated invoices belonging to the oldest |
| | invoices by due date. |
| 4 | Quantifies a number of other data transfer |
| | instructions that are partially satisfied. |
| | In various practical applications, this vector |
| | element may represent a number of other |
| | invoices that are partially allocated. |
| 5 | Quantifies whether any digital resources were |
| | previously reserved (may be a binary |
| | indicator). |
| | In various practical applications, this vector |
| | element may represent a number of |
| | allocations set aside or whether any |
| | allocations were previously set aside. |
| 6 | Quantifies whether any actions were taken to |
| | recover the previously reserved digital |
| | resources (may be a binary indicator). |
| | In various practical applications, this vector |
| | element may represent a number of actions |
| | taken to recover the amount that was set |
| | aside. |

In various implementations, the “oldest invoices by due date” list referenced in Table 3 is generated by sorting all routing instructions associated with the source entity in ascending order of their due dates, then selecting them successively until the total requested digital resources meets or exceeds the payload 1208. In some examples, each vector is normalized to a value. Normalization ensures that subsequent analysis of the vectors (for example, by downstream machine learning models) focuses on detecting proportional relationships between vector components, independent of the absolute magnitudes of the components (e.g., independent of an absolute number of associated actions, invoices, etc.). For example, the elements of the vector are scaled up or down so that the magnitude of the vector is equal to the value. By scaling each vector to a standard magnitude, the downstream analysis highlights the inherent structure and/or relative significance of the components. This approach may eliminate analytical biases introduced by differences in scale, allowing for consistent comparison and pattern recognition based on relative proportions, which may facilitate the identification of like vectors with similar proportional relationships between their components. In various implementations, each vector is normalized to a value of about 1 (e.g., a unit vector). In some examples, the context-aware data transfer model 612 generates a vector having the same element types for each candidate routing instruction.

In the example message sequence chart 1000, the context-aware data transfer model 612 generates a reference vector representing characteristics of all previously completed data transfers associated with the source entity (at operation 1018). In various implementations, the reference vector is constructed using the same element types as the vectors generated for the candidate routing instructions. In some instances, each element of the reference vector is computed based on aggregated characteristics derived from routing instructions associated with all previously completed data transfers for the source entity.

In some examples, the context-aware data transfer model 612 stores the vectors generated for each candidate routing instruction in the explainability database 618, along with definitions or descriptions of the vector elements. Additionally, in some instances, the context-aware data transfer model 612 stores the reference vector in the explainability database 618, similarly accompanied by definitions or descriptions of its elements. By saving these vectors and their associated metadata, the explainability database 618 maintains a traceable record or log of the recommendations generated by the context-aware data transfer model 612. This audit trail provides transparency and allows user devices 108 to access detailed information about the decision-making process.

In the example message sequence chart 1000, the context-aware data transfer model 612 generates candidate routing instructions by comparing the vector representations of the candidate routing instructions to the reference vector (at operation 1020). For example, the context-aware data transfer model 612 computes a distance metric between each vector representation of a candidate routing instruction and the reference vector, ranking the candidate routing instructions based on the calculated distances. In various implementations, the distance metric is computed as a scalar product. In some examples, candidate routing instructions with vectors that are closer to the reference vector (indicating greater similarity) are ranked higher. In some instances, the context-aware data transfer model 612 sorts the candidate routing instructions in descending order of similarity and select the top-ranked candidates as the final candidate routing instructions. In some embodiments, the context-aware data transfer model 612 computes a confidence score for each candidate routing instruction and selects only those candidate routing instructions with a confidence score exceeding a predefined threshold as final candidate routing instructions. In various implementations, confidence scores are computed based on the distance metric and stored in the explainability database 618, for example, along with the corresponding candidate routing instructions, ensuring traceability and transparency in the decision-making process.

In the example message sequence chart 1000, the data transfer application 608 outputs the final candidate routing instructions to the user device 108 (at operation 1022). In various implementations, the final candidate routing instructions are the candidate routing instructions generated by the pattern-matching data transfer model 610 at operation 1008. In some examples, the final candidate routing instructions are the final candidate routing instructions selected by the context-aware data transfer model 612 at operation 1020. In the example message sequence chart 1000, the user device 108 confirms the final candidate routing instructions and transmits the confirmation to the data transfer application 608 (at operation 1024). For example, a user may review the final candidate routing instructions via a graphical user interface and select one of the final candidate routing instructions. The user device 108 may transmit the confirmation including the selected final candidate routing instructions to the data transfer application 608. In various implementations, the most similar previously validated candidate routing instructions may also be output via the graphical user interface.

In the example message sequence chart 1000, the data transfer application 608 may transfer a command to the database management application 208 of the source node 102 (e.g., the source node 102 identified as including the source entity) to transmit digital resources in accordance with the selected candidate routing instructions (at block 1026). In response to receiving the command, the database management application 208 may transmit a data package including the digital resources to the database management application 408 at the appropriate destination node 104 (at block 1028). For example, the candidate routing instructions 1302 identify a source entity (e.g., entity 302), a destination entity (e.g., entity 502), a payload specifying the value of digital resources to be transferred, a data transfer instruction identifier, and any relevant metadata. Based on these candidate routing instructions, the data transfer system 100 generates a command instructing the database management application 208 to transfer digital resources from the source entity 302 (identified by the unique identifier 306) to the destination entity 502 (identified by the unique identifier 506).

In response to receiving the command, the database management application 208 locates the source entity 302 using the unique identifier 306, decrements the value indicator 308 by the amount specified in the command, and packages the digital resources for transfer. Upon receiving the resulting data package, the database management application 408 locates the destination entity 502 by referencing the unique identifier 506 and increments the value indicator 508 to reflect the amount of transferred digital resources, as indicated in the data package.

In various implementations, the entities are implemented as class-based data structures. The database management application 208 locates the class-based object representing entity 302 (identified by the unique identifier 306) and decrements its value indicator 308 by the amount of digital resources indicated by the command. This updated class-based object is then serialized or packaged into a data package for transmission to the database management application 408. In turn, the database management application 408 locates or creates the class-based object for entity 502 (identified by the unique identifier 506) and increments its value indicator 508 by the transferred amount to finalize the update.

In some instances, the entities are implemented as struct or record-based data structures. Upon receiving the command, the database management application 208 retrieves the record associated with entity 302, locates the field corresponding to the value indicator 308, and decrements that field by the specified amount. The updated record is then placed into a data package and transmitted to the database management application 408. After receiving the data package, the database management application 408 looks up the record for entity 502, increments the value indicator 508 field by the transferred amount, and saves the updated record in local storage.

In some examples, the entities are implemented as dictionary-based representations. The database management application 208 locates the dictionary associated with entity 302 (including keys for the unique identifier 306 and value indicator 308) and decrements the value indicator key (e.g., corresponding to the value indicator 308) by the specified transfer amount. The revised dictionary is placed into a data package and transmitted to the database management application 408. Upon receipt, the database management application 408 locates or creates the dictionary for entity 502, increments the value indicator key (e.g., corresponding to the value indicator 508) by the transferred amount, and then persists this updated dictionary to storage.

In various implementations, the entities are implemented as graph-based representations. When processing a command to transfer resources from entity 302 to entity 502, the database management application 208 locates the source node (identified by unique identifier 306) and decrements the value indicator attribute (e.g., corresponding to the value indicator 308) by the specified transfer amount. The database management application 208 then generates or updates any necessary edges reflecting the transfer and sends this data to the database management application 408. Upon receiving the data, the database management application 408 locates or creates the destination node for entity 502, increments its value indicator attribute (e.g., corresponding to the value indicator 508) by the transferred amount, and finalizes the graph updates locally.

In some instances, the entities are implemented using a relational database schema. The database management application 208 issues an update statement against the table row representing entity 302, decrementing the value indicator column (e.g., corresponding to the value indicator 308) by the specified transfer amount. The database management application 208 packages this updated row information into a data package and sends it to the database management application 408. In response, the database management application 408 runs an update statement on the table row representing entity 502, incrementing its value indicator column (e.g., corresponding to the value indicator 508) by the transferred amount, thus reflecting the finalized transfer.

In some examples, the entities are implemented as JSON objects. The database management application 208 retrieves the JSON object for entity 302 (including fields such as a unique identifier field corresponding to the unique identifier 306 and a value indicator field corresponding to the value indicator 308), decrements the value indicator field by the transfer amount, and encapsulates the updated JSON in a data package. The database management application 208 transmits this package to the database management application 408, which parses the JSON object for entity 502 (including unique identifier field corresponding to the unique identifier 506 and the value indicator field corresponding to the value indicator 508) and increments the value indicator field accordingly. This updated JSON object is then saved locally to finalize the transfer.

In various implementations, the entities are implemented as immutable data structures (e.g., tuples). The database management application 208 creates a new tuple representing the updated state of entity 302 by copying the previous tuple and decrementing the field corresponding to the value indicator 308. This new tuple is transmitted to the database management application 408, which similarly creates a new tuple for entity 502 with its value indicator 508 incremented by the transferred amount. The original tuples remain unchanged for auditing, while the newly created tuples represent the current states of both entities.

The following paragraphs provide examples of systems, methods, and devices implemented in accordance with this specification.

Example 1. A system, comprising: non-transitory computer-readable storage media storing instructions; and an electronic processor configured to execute the instructions to: receive a data transfer request, the data transfer request identifying a source entity and including a payload identifying a value, validate a set of completed data transfers associated with the source entity against a set of heuristics, in response to determining that multiple heuristics are validated or that no heuristics are validated: initialize a set of logical rules based on the set of completed data transfers; select a first subset of a set of routing instructions based on the initialized set of logical rules; select a second subset of the first subset of routing instructions, wherein a sum of payloads of the second subset of routing instructions is substantially equal to the payload of the data transfer request; generate a vector representation for each routing instruction of the second subset of routing instructions; generate a reference vector based on the completed data transfers; and select candidate routing instructions from the second subset of routing instructions based on a comparison between each vector representation and the reference vector, and output the candidate routing instructions to a user device via a graphical user interface.

Example 2. The system of example 1, wherein the electronic processor is configured to execute the instructions to: transmit a data transfer command to a source node identified by the candidate routing instructions; wherein, in response to receiving the data transfer command, the source node is configured to transmit a data package to a destination node.

Example 3. The system of example 1, wherein the comparison between each vector representation and the reference vector includes computing a distance metric between each vector representation and the reference vector.

Example 4. The system of example 3, wherein each vector representation is normalized and the distance metric includes a scalar product.

Example 5. The system of example 3, wherein the electronic processor is configured to execute the instructions to compute a confidence score based on the distance metric.

Example 6. The system of example 5, wherein the electronic processor is configured to execute the instructions to select a third subset of the second subset of routing instructions having a confidence score exceeding a predefined threshold as candidate routing instructions.

Example 7. The system of example 1, wherein the comparison between each vector representation and the reference vector includes ranking each vector representation according a distance between the vector representation and the reference vector.

Example 8. The system of example 7, wherein the electronic processor is configured to execute the instructions to select a subset of the ranked vector representations as candidate routing instructions.

Example 9. The system of example 5, wherein the electronic processor is configured to execute the instructions to store at least one of the vector representation, the reference vector, and the confidence score to an explainability log.

Example 10. The system of example 1, wherein the electronic processor is configured to execute the instructions to: in response to determining that only a single heuristic is validated, generate candidate routing instructions based on the single heuristic.

Example 11. A computer implemented method, comprising: receiving, at a data transfer management platform, a data transfer request, the data transfer request identifying a source entity and including a payload identifying a value, validating, at the data transfer management platform, a set of completed data transfers associated with the source entity against a set of heuristics, in response to determining that multiple heuristics are validated or that no heuristics are validated: initializing, at the data transfer management platform, a set of logical rules based on the set of completed data transfers; selecting, at the data transfer management platform, a first subset of a set of routing instructions based on the initialized set of logical rules; selecting, at the data transfer management platform, a second subset of the first subset of routing instructions, wherein a sum of payloads of the second subset of routing instructions is substantially equal to the payload of the data transfer request; generating, at the data transfer management platform, a vector representation for each routing instruction of the second subset of routing instructions; generating, at the data transfer management platform, a reference vector based on the completed data transfers; and selecting, at the data transfer management platform, candidate routing instructions from the second subset of routing instructions based on a comparison between each vector representation and the reference vector, and outputting, from the data transfer management platform, the candidate routing instructions to a user device via a graphical user interface.

Example 12. The method of example 11, further comprising: transmitting a data transfer command to a source node identified by the candidate routing instructions; wherein, in response to receiving the data transfer command, the source node is configured to transmit a data package to a destination node.

Example 13. The method of example 11, wherein the comparison between each vector representation and the reference vector includes computing a distance metric between each vector representation and the reference vector.

Example 14. The method of example 13, wherein each vector representation is normalized and the distance metric includes a scalar product.

Example 15. The method of example 13, further comprising computing a confidence score based on the distance metric.

Example 16. The method of example 15, further comprising selecting a third subset of the second subset of routing instructions having a confidence score exceeding a predefined threshold as candidate routing instructions.

Example 17. The method of example 11, wherein the comparison between each vector representation and the reference vector includes ranking each vector representation according a distance between the vector representation and the reference vector.

Example 18. The method of example 17, further comprising selecting a subset of the ranked vector representations as candidate routing instructions.

Example 19. The method of example 15, further comprising storing at least one of the vector representation, the reference vector, and the confidence score to an explainability log.

Example 20. A non-transitory computer-readable storage medium comprising instructions that, when executed by an electronic processor, cause the electronic processor to perform a set of operations comprising: receiving a data transfer request, the data transfer request identifying a source entity and including a payload identifying a value; validating a set of completed data transfers associated with the source entity against a set of heuristics; in response to determining that multiple heuristics are validated or that no heuristics are validated: initializing a set of logical rules based on the set of completed data transfers, selecting a first subset of a set of routing instructions based on the initialized set of logical rules, selecting a second subset of the first subset of routing instructions, wherein a sum of payloads of the second subset of routing instructions is substantially equal to the payload of the data transfer request, generating a vector representation for each routing instruction of the second subset of routing instructions, generating a reference vector based on the completed data transfers, and selecting candidate routing instructions from the second subset of routing instructions based on a comparison between each vector representation and the reference vector; in response to determining that only a single heuristic is validated, generating candidate routing instructions based on the single heuristic; and outputting the candidate routing instructions to a user device via a graphical user interface.

The foregoing description is merely illustrative in nature and does not limit the scope of the disclosure or its applications. The broad teachings of the disclosure may be implemented in many different ways. While the disclosure includes some particular examples, other modifications will become apparent upon a study of the drawings, the text of this specification, and the following claims. In the written description and the claims, one or more processes within any given method may be executed in a different order- or processes may be executed concurrently or in combination with each other-without altering the principles of this disclosure. Similarly, instructions stored in a non-transitory computer-readable medium may be executed in a different order- or concurrently-without altering the principles of this disclosure. Unless otherwise indicated, the numbering or other labeling of instructions or method steps is done for convenient reference and does not necessarily indicate a fixed sequencing or ordering.

It should also be noted that a plurality of hardware and software-based devices, as well as a plurality of different structural components may be utilized in various implementations. Aspects, features, and instances may include hardware, software, and electronic components or modules that, for purposes of discussion, may be illustrated and described as if the majority of the components were implemented solely in hardware. However, one of ordinary skill in the art, and based on a reading of this detailed description, would recognize that, in at least one instance, the electronic based aspects of the invention may be implemented in software (for example, stored on non-transitory computer-readable medium) executable by one or more processors. As a consequence, it should be noted that a plurality of hardware and software-based devices, as well as a plurality of different structural components may be utilized to implement the invention. For example, “control units” and “controllers” described in the specification can include one or more electronic processors, one or more memories including a non-transitory computer-readable medium, one or more input/output interfaces, and various connections (for example, a system bus) connecting the components.

Unless the context of their usage unambiguously indicates otherwise, the articles “a,” “an,” and “the” should not be interpreted to mean “only one.” Rather, these articles should be interpreted to mean “at least one” or “one or more.” Likewise, when the terms “the” or “said” are used to refer to a noun previously introduced by the indefinite article “a” or “an,” the terms “the” or “said” should similarly be interpreted to mean “at least one” or “one or more” unless the context of their usage unambiguously indicates otherwise.

It should also be understood that although certain drawings illustrate hardware and software located within particular devices, these depictions are for illustrative purposes only. In some examples, the illustrated components may be combined or divided into separate software, firmware, and/or hardware. For example, instead of being located within and performed by a single electronic processor, logic and processing may be distributed among multiple electronic processors. Regardless of how they are combined or divided, hardware and software components may be located on the same computing device or may be distributed among different computing devices connected by one or more networks or other suitable connections or links.

Thus, in the claims, if an apparatus or system is claimed, for example, as including an electronic processor or other element configured in a certain manner, for example, to make multiple determinations, the claim or claim element should be interpreted as meaning one or more electronic processors (or other element) where any one of the one or more electronic processors (or other element) is configured as claimed, for example, to make some or all of the multiple determinations collectively. To reiterate, those electronic processors and processing may be distributed.

Spatial and functional relationships between elements—such as modules—are described using terms such as (but not limited to) “connected,” “engaged,” “interfaced,” and/or “coupled.” Unless explicitly described as being “direct,” relationships between elements may be direct or include intervening elements. The phrase “at least one of A, B, and C” should be construed to indicate a logical relationship (A OR B OR C), where OR is a non-exclusive logical OR, and should not be construed to mean “at least one of A, at least one of B, and at least one of C.” The term “set” does not necessarily exclude the empty set. For example, the term “set” may have zero elements. The term “subset” does not necessarily require a proper subset. For example, a “subset” of set A may be coextensive with set A, or include elements of set A. Furthermore, the term “subset” does not necessarily exclude the empty set.

In the figures, the directions of arrows generally demonstrate the flow of information—such as data or instructions. The direction of an arrow does not imply that information is not being transmitted in the reverse direction. For example, when information is sent from a first element to a second element, the arrow may point from the first element to the second element. However, the second element may send requests for data to the first element, and/or acknowledgements of receipt of information to the first element. Furthermore, while the figures illustrate a number of components and/or steps, any one or more of the components and/or steps may be omitted or duplicated, as suitable for the application and setting.

Additionally, operations (such as processes, decisions, inputs, outputs, actions, messages, interactions, events, and/or any other operations) shown in the flowcharts and/or message sequence charts may be illustrated once each and in a particular order in the drawings. However, in various implementations, the operations may be reordered and/or repeated as may be suitable. In some examples, different operations may be performed in parallel, as may be appropriate.

The term computer-readable medium does not encompass transitory electrical or electromagnetic signals or electromagnetic signals propagating through a medium—such as on an electromagnetic carrier wave. The term “computer-readable medium” is considered tangible and non-transitory. The functional blocks, flowchart elements, and message sequence charts described above serve as software specifications that can be translated into computer programs by the routine work of a skilled technician or programmer.

What is claimed is:

1. A system, comprising:
non-transitory computer-readable storage media storing instructions; and
an electronic processor configured to execute the instructions to:
receive a data transfer request, the data transfer request identifying a source entity and including a payload identifying a value,
validate a set of completed data transfers associated with the source entity against a set of heuristics,
in response to determining that multiple heuristics are validated or that no heuristics are validated:
initialize a set of logical rules based on the set of completed data transfers;
select a first subset of a set of routing instructions based on the initialized set of logical rules;
select a second subset of the first subset of routing instructions, wherein a sum of payloads of the second subset of routing instructions is substantially equal to the payload of the data transfer request;
generate a vector representation for each routing instruction of the second subset of routing instructions;
generate a reference vector based on the completed data transfers; and
select candidate routing instructions from the second subset of routing instructions based on a comparison between each vector representation and the reference vector, and
output the candidate routing instructions to a user device via a graphical user interface.

2. The system of claim 1, wherein the electronic processor is configured to execute the instructions to:
transmit a data transfer command to a source node identified by the candidate routing instructions;
wherein, in response to receiving the data transfer command, the source node is configured to transmit a data package to a destination node.

3. The system of claim 1, wherein the comparison between each vector representation and the reference vector includes computing a distance metric between each vector representation and the reference vector.

4. The system of claim 3, wherein each vector representation is normalized and the distance metric includes a scalar product.

5. The system of claim 3, wherein the electronic processor is configured to execute the instructions to compute a confidence score based on the distance metric.

6. The system of claim 5, wherein the electronic processor is configured to execute the instructions to select a third subset of the second subset of routing instructions having a confidence score exceeding a predefined threshold as candidate routing instructions.

7. The system of claim 1, wherein the comparison between each vector representation and the reference vector includes ranking each vector representation according a distance between the vector representation and the reference vector.

8. The system of claim 7, wherein the electronic processor is configured to execute the instructions to select a subset of the ranked vector representations as candidate routing instructions.

9. The system of claim 5, wherein the electronic processor is configured to execute the instructions to store at least one of the vector representation, the reference vector, and the confidence score to an explainability log.

10. The system of claim 1, wherein the electronic processor is configured to execute the instructions to:
in response to determining that only a single heuristic is validated, generate candidate routing instructions based on the single heuristic.

11. A computer implemented method, comprising:
receiving, at a data transfer management platform, a data transfer request, the data transfer request identifying a source entity and including a payload identifying a value,
validating, at the data transfer management platform, a set of completed data transfers associated with the source entity against a set of heuristics,
in response to determining that multiple heuristics are validated or that no heuristics are validated:
initializing, at the data transfer management platform, a set of logical rules based on the set of completed data transfers;
selecting, at the data transfer management platform, a first subset of a set of routing instructions based on the initialized set of logical rules;
selecting, at the data transfer management platform, a second subset of the first subset of routing instructions, wherein a sum of payloads of the second subset of routing instructions is substantially equal to the payload of the data transfer request;
generating, at the data transfer management platform, a vector representation for each routing instruction of the second subset of routing instructions;
generating, at the data transfer management platform, a reference vector based on the completed data transfers; and
selecting, at the data transfer management platform, candidate routing instructions from the second subset of routing instructions based on a comparison between each vector representation and the reference vector, and
outputting, from the data transfer management platform, the candidate routing instructions to a user device via a graphical user interface.

12. The method of claim 11, further comprising:
transmitting a data transfer command to a source node identified by the candidate routing instructions;
wherein, in response to receiving the data transfer command, the source node is configured to transmit a data package to a destination node.

13. The method of claim 11, wherein the comparison between each vector representation and the reference vector includes computing a distance metric between each vector representation and the reference vector.

14. The method of claim 13, wherein each vector representation is normalized and the distance metric includes a scalar product.

15. The method of claim 13, further comprising computing a confidence score based on the distance metric.

16. The method of claim 15, further comprising selecting a third subset of the second subset of routing instructions having a confidence score exceeding a predefined threshold as candidate routing instructions.

17. The method of claim 11, wherein the comparison between each vector representation and the reference vector includes ranking each vector representation according a distance between the vector representation and the reference vector.

18. The method of claim 17, further comprising selecting a subset of the ranked vector representations as candidate routing instructions.

19. The method of claim 15, further comprising storing at least one of the vector representation, the reference vector, and the confidence score to an explainability log.

20. A non-transitory computer-readable storage medium comprising instructions that, when executed by an electronic processor, cause the electronic processor to perform a set of operations comprising:
receiving a data transfer request, the data transfer request identifying a source entity and including a payload identifying a value;
validating a set of completed data transfers associated with the source entity against a set of heuristics;
in response to determining that multiple heuristics are validated or that no heuristics are validated:
initializing a set of logical rules based on the set of completed data transfers,
selecting a first subset of a set of routing instructions based on the initialized set of logical rules,
selecting a second subset of the first subset of routing instructions, wherein a sum of payloads of the second subset of routing instructions is substantially equal to the payload of the data transfer request,
generating a vector representation for each routing instruction of the second subset of routing instructions,
generating a reference vector based on the completed data transfers, and
selecting candidate routing instructions from the second subset of routing instructions based on a comparison between each vector representation and the reference vector;
in response to determining that only a single heuristic is validated, generating candidate routing instructions based on the single heuristic; and
outputting the candidate routing instructions to a user device via a graphical user interface.
